(19) United States
(12) Patent Application Publication
(10) Pub. No.: US 2009/0020609 A1
(43) Pub. Date: Jan. 22, 2009

(54) SENSOR-EMBEDDED BARCODES

(76) Inventors: Marc H. Cohen, Silver Spring, MD (US); Kenneth A. Gabriel, Alexandria, VA (US)

Correspondence Address: Rahman LLC, 10025 Governor Warfield Parkway, Suite 110, Columbia, MD, 21044, US

(21) Appl. No.: 12/171,454

(22) Filed: Jul. 11, 2008

Related U.S. Application Data
(60) Provisional application No. 60/959,620, filed on Jul. 16, 2007.

(51) Int. Cl. G06K 19/06; G06K 7/10

(52) U.S. Cl. 235/462.01; 235/494

(57) ABSTRACT

A barcode includes sensors or actuators in selected modules whereby its code changes to indicate exposure to, or change in, one or more properties of interest. Prior to exposure, the barcode displays a first code. After exposure, the barcode displays a different code. The displayed code conveys qualitative or quantitative information about one or more chosen properties of interest. This dynamic barcode can be configured as a standalone device or as a label that can be affixed to an object. Data coded by the dynamic barcode is machine-readable or visible to the naked eye, and can be autonomously conveyed to a database to facilitate analysis or prognostics.

### CROSS-REFERENCE TO RELATED APPLICATIONS

This application claims the benefit of U.S. provisional patent application No. 60/959,620 filed on Jul. 16, 2007, the complete disclosure of which, in its entirety, is herein incorporated by reference.

### BACKGROUND

1. Technical Field

The embodiments herein relate to barcodes, and, more particularly, to enhancing static barcodes through the addition of sensors or actuators to become dynamic barcode labels or dynamic barcode devices.

2. Description of the Related Art

A barcode is a graphical representation of a symbol set whose characters are displayed such that they are machine readable with conventional barcode scanning equipment. Barcodes are most commonly used to automatically identify an item or class of items and are ubiquitous because they are extremely low cost; they can be printed using conventional printing methods directly onto a product, onto the product's container or as a label that can be affixed to a product. Furthermore there exists a large infrastructure for printing and reading barcodes as well as databases for performing inventory management and logistics in almost all industries.

Many types of barcode symbol sets have been invented and developed for a variety of applications. A one-dimensional monochrome barcode typically consists of modules of alternating vertical bar and space patterns whose widths specify the module's character. A sequence of such modules determines the barcode's displayed code and an additional check character if necessary. Some examples of commonly used one-dimensional symbol sets are: (i) the Universal Product Code (UPC), introduced to provide an efficient method of matching a product against a database containing pricing and inventory information as well as recording a sale; (ii) CODE-39 (three of nine), normal and full ASCII versions, are used extensively by the Department of Defense for logistics, to inventory, track and trace items of interest. CODE-39 is an extensible code allowing for a greater quantity of data to be included in the barcode's displayed code. (iii) POSTNET barcodes are used extensively by the USPS to code ZIP Code information for automatic mail sorting by zip code.

Two-dimensional barcodes were invented and developed to increase the data density and decrease the overall size of barcodes. Typically, the low level structure of a symbol consists of an array of code words (small bar and space patterns) that are grouped together and stacked on top of each other to produce the complete printed symbol. Examples of commonly used two-dimensional monochrome symbol sets are: (i) Portable Data File 417 (PDF417) can code as many as 2725 data characters in a single bar code. The complete specification for PDF417 provides many coding options including data compaction options, error detection and correction options, and variable size and aspect ratio symbols. This symbol set was designed by Symbol Technologies, Inc. (now Motorola) to fulfill the need for higher density bar codes. (ii) MAXICODE is a fixed size matrix style symbol set which is made up of offset rows of hexagonal modules arranged around a bulls-eye finder pattern. This symbol set was designed by United Parcel Service for package tracking applications. (iii) DATAMATRIX is a high density 2 dimensional matrix style barcode symbol set that can code up to 3116 characters from the entire 256 byte ASCII character set. The symbol is built on a square grid arranged with a finder pattern around the perimeter of the barcode symbol.

IBM invented grayscale one-dimensional barcodes, as taught in U.S. Pat. No. 5,619,026 to Chou et. al., Apr. 8, 1977, whereby a non-standard decoding algorithm provides enhanced security for holograms or other authentication devices at very low cost. The grayscale pattern includes a predetermined pattern which includes vertical stripes of varying gray-level and width.

Xerox formulated a two-dimensional color bar-coding scheme as described in U.S. Pat. No. 5,946,414 to Cass and Tong, Aug. 31, 1999, whereby the color-space direction is computed to be simultaneously detectable by a digital image capture device, such as a scanner, and substantially imperceptible to a human viewer. Very high data density can be achieved.

Microsoft Research has developed a color barcode symbol set called High Capacity Color Barcode (HCCB) format as described in European patent application 05105314.8, to Jancke, Jun. 16, 2005. These pseudo three-dimensional barcodes hold far more data in less space than monochrome or gray-scale symbol sets and allow for advanced security features. The HCCB format achieves this by using a specific barcode symbol shape in combination with multiple colors per symbol. Using eight colors yields 3,500 alphabetical characters per square inch in its highest density form (600 dots per inch), equivalent to two pages of a novel. The symbol size can be changed to accommodate the differing fidelities of imaging devices (cameras, cell phone cameras and web-cams). The barcode can be printed using an inkjet or laser jet printer.

Three-dimensional barcodes, currently being developed, can store information extremely densely. A cube measuring 30 micrometers across can store several volumes of an encyclopedia. These barcodes include high levels of encryption and have applications in the provenance and security of expensive items. Non-standard, costly methods are required to make the barcodes and non-standard readers are necessary to read these barcodes.

The above-mentioned barcodes are all static in that they code for a predetermined fixed sequence of alphanumeric characters. Conventional solutions also teach the integration of two different sensor types within a barcode. First, a dynamic barcode in U.S. Pat. No. 5,929,422 to Lappe, Jul. 27, 1999 and U.S. Pat. No. 6,036,092 also to Lappe, Mar. 14, 2000, is limited to assaying systems, and more specifically to the analysis of a test volume of physiological fluid. Lappe's embodiments disclose a qualitative means to determine the presence or absence of at least one specific substance in the physiological sample fluid by changing the optical reflectance, and thereby the code, of the corresponding character or characters in a one-dimensional (linear) barcode. The barcode is machine-readable, and the identity, type of test and test result can be communicated to a remote location.

The machine-readable dynamic barcode in U.S. Pat. No. 6,770,487 to Crosby, Aug. 3, 2004, is substantially similar to Lappe's embodiments cited above. Here, the dynamic barcode is specifically aimed at diagnostic test strips, dip-stick or lateral flow type assays that also require the application of a fluid sample. Whereas Lappe's machine-readable assaying system was limited to “yes-no” (qualitative) reporting, Crosby's machine-readable diagnostic strip test claims qualitative as well as semi-quantitative reporting of test results. At least one test zone, consisting of at least one chosen antibody and a quality control zone are located at different sites within the one-dimensional barcode. Crosby indicates that this can be accomplished using a single vertically striped zone located within one or more characters of the linear barcode. Changing a single striped zone in a valid linear barcode character does not change the character; it does however result in an unreadable barcode. Crosby's machine-readable diagnostic strip test can include more than one test zone to determine the presence of: (i) different amounts of one analyte (semi-quantitative), (ii) different amounts of more than one analyte (semi-quantitative), or (iii) a first set of analytes (qualitative) as well as the amount of a different analyte (semi-quantitative).

Second, a very specific embodiment of a dynamic barcode is taught in U.S. Pat. No. 6,685,094 to Cameron, Feb. 3, 2004. A dynamic, machine-readable thermochromic barcode is used for tracking certain products' environmental temperatures thereby identifying the location from where the product was taken. The thermochromic barcode integrates temperature sensitive inks into one or more characters of the barcode. As such, the thermochromic barcode can be considered as two separate barcodes that occupy the same physical space, each barcode being exclusively visible above or below a pre-specified fixed temperature. Cameron teaches how at least two thermochromic characters are required for a thermochromic UPC barcode; the first alters a character within the barcode's identification number and the second alters a required checksum character.

In particular, in the conventional solutions the sensed or measured properties are confined to: (i) assays or diagnostic tests that require physiological fluid samples, and (ii) product temperature. Furthermore there are no provisions that allow for: (i) the interspersing of unchangeable data with changeable data, (ii) the interspersing of reversible indicia with irreversible indicia, (iii) the conveying of data from external sensors or databases, or (iv) the use of extensible barcodes.

### SUMMARY

In view of the foregoing, an embodiment herein provides a versatile dynamic sensor-embedded barcode by integrating within the barcode, one or more different types of sensor modules, each utilizing one or more valid barcode characters to code one or more properties of interest. Properties of interest include, but are not limited to, physical variables, environmental variables, electromagnetic variables, explosive and chemical variables, nuclear and radiological variables, biological and physiological variables, in-vitro diagnostic test variables, tests for drugs of abuse, tests for and of pharmaceuticals and nutraceuticals, tests for beverage and food toxins or any combinations thereof.

The embodiments herein also provide a machine readable sensor-embedded barcode to sense or measure properties of interest that are internal or external to the barcode and render this information using one or more barcode characters; a machine readable sensor-embedded barcode to obtain data from external sources and render this information using one or more barcode characters; a machine-readable sensor-embedded barcode that includes unchangeable data and changeable data in contiguous regions of the barcode; a machine-readable sensor-embedded barcode that includes unchangeable data and changeable data in interspersed regions of the barcode; a track-able and traceable machine-readable sensor-embedded barcode that renders and retains data from past or present sensed, measured or obtained events; a machine readable sensor-embedded barcode that codes qualitative “yes-no” data; a machine readable sensor-embedded barcode that codes quantitative “thermometer code” data; a machine-readable sensor-eEmbedded barcode that codes data with reversible indicia; a machine-readable sensor-embedded barcode that codes data with irreversible indicia; a sensor-embedded barcode that renders one or more sensor module's characters visible to the naked eye; a machine-readable standalone sensor-embedded barcode device; and a machine-readable sensor-embedded barcode label that can be affixed to an object.

### BRIEF DESCRIPTION OF THE DRAWINGS

The embodiments herein will be better understood from the following detailed description with reference to the drawings, in which:

FIGS. 1A and 1B illustrate an example of an extensible CODE-39 machine-readable sensor-embedded dynamic barcode, having contiguous unchangeable and changeable regions, prior to and after exposure to one or more properties of interest, respectively according to the embodiments herein;

FIGS. 2A and 2B illustrate an example of an extensible CODE-39 machine-readable sensor-embedded dynamic barcode, having interspersed unchangeable and changeable regions, prior to and after exposure to one or more properties of interest, respectively according to the embodiments herein;

FIG. 3A is an illustrative example of one or more intrinsic or extrinsic properties of interest that can be sensed or obtained by sensors or actuators, internal or external to the machine-readable sensor-embedded dynamic barcode according to the embodiments herein;

FIG. 3B is an illustrative example of an extensible CODE-39 machine-readable sensor-embedded dynamic barcode of the embodiments herein where, at least one of the extrinsic properties of interest are obtained from at least one external sensor whereby the data is coded by at least module of the changeable regions of the barcode according to the embodiments herein;

FIGS. 4A and 4B are illustrative examples of an extensible CODE-39 machine-readable sensor-embedded dynamic barcode configured to qualitatively code for four different properties of interest according to the embodiments herein;

FIGS. 5A through 5E are illustrative examples of an extensible CODE-39 machine-readable sensor-embedded dynamic barcode configured to portray a quantitative thermometer code for one property of interest as this property changes according to the embodiments herein;

FIG. 6 is an illustrative example of an extensible CODE-39 machine-readable sensor-embedded dynamic barcode device according to the embodiments herein; and

FIG. 7 is an illustrative example of an extensible CODE-39 machine-readable sensor-embedded dynamic barcode label according to the embodiments herein.

### DETAILED DESCRIPTION AND PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For purposes of simplicity, a one-dimensional barcode symbol set that uses CODE-39 characters and features is depicted in all figures. Furthermore, the sensor modules are depicted as changing their state from narrow black bars to wide black bars. Depending on the chosen symbol set, a sensor module's changed state could be realized by any number of indicia including, but not limited to, changing from wide to narrow, from black to white, from transparent to opaque, from one color to another, from one shape to another, from one character to another, from reflective to non-reflective, from rough to smooth, from shallow to deep, from non-conductive to conductive, or from non-magnetic to magnetic. Alternatively, the changed state of the sensor module could be realized by the opposite sequence of change for each of the abovementioned indicia or by a combination of the abovementioned indicia.

The embodiments herein specifically includes the Embedding of sensor modules in barcodes that comprise one-, two- or three-dimensional symbol sets that render their codes using one or more features including, but not limited to, monochrome, grey level or color characters as well as surface reflectivity, surface texture, surface roughness or surface depth.

The figures apply equally to machine-readable sensor-embedded dynamic barcodes or to sensor-embedded dynamic barcodes that are visible to the naked eye. The figures apply equally to reversible or irreversible sensor-embedded modules or any combinations thereof. The figures apply equally to contiguous or interspersed unchangeable regions or indicia with changeable regions or indicia.

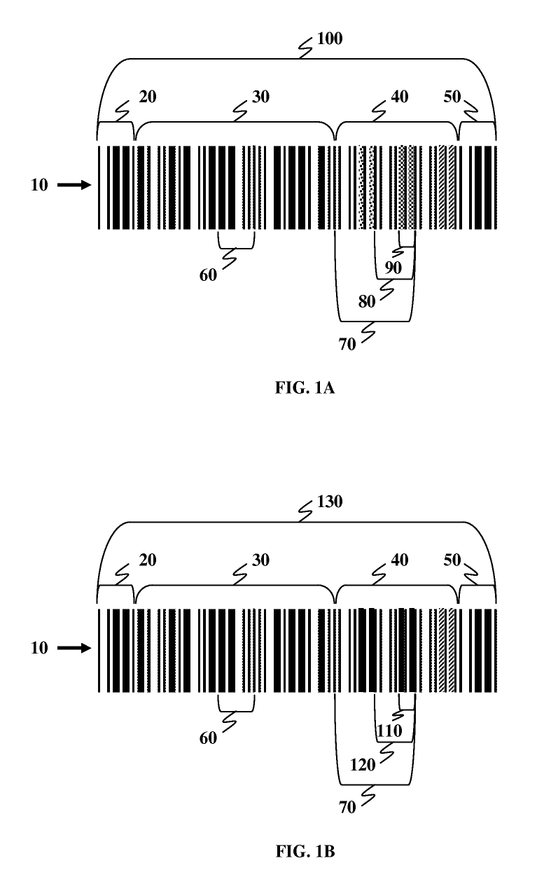

Embedded sensor modules can measure properties that include, but are not limited to, physical variables, environmental variables, electromagnetic variables, explosive and chemical variables, nuclear and radiological variables, biological and physiological variables, in-vitro diagnostic test variables, tests for drugs of abuse, tests for and of pharmaceuticals and nutraceuticals, tests for beverage and food toxins or any combinations thereof. Referring now to the drawings and, more particularly to FIGS. 1A through 7, where similar reference characters denote corresponding features consistently throughout the figures, there are shown preferred embodiments.

A preferred embodiment of the machine-readable sensor-embedded dynamic barcode of the embodiments herein is illustrated in FIG. 1A. The machine-readable sensor-embedded dynamic barcode 10 comprises a start character 20, followed by one or more unchangeable regions 30, one or more changeable regions 40, and a termination character 50. Each unchangeable region 30 comprises at least one fixed valid data character 60. Each changeable region 40 comprises at least one sensor module 70. Each sensor module 70 comprises at least one valid character 80 containing at least two sensing indicia 90 that respond to a property or to a level of a property of interest. Before exposure to the property or level of property of interest, the sensing indicia 90 are in an initial state and the sensor-embedded dynamic barcode 10 conveys a first code 100. The location and size of the sensing indicia 90 must be precisely chosen so that if and when they are exposed to one or more properties or to one or more levels of one or more properties of interest, their state changes (for example from transparent to opaque, or from narrow to wide), and they represent a different valid character.

FIG. 1B illustrates the preferred embodiment of the machine-readable sensor-embedded dynamic barcode of the embodiments herein as illustrated in FIG. 1A, after exposure to the property or to a level of the property of interest. The machine-readable sensor-embedded dynamic barcode 10 retains the same overall format; a start character 20, one or more unchangeable regions 30, one or more changeable regions 40 and a termination character 50. The sensing indicia's initial states 90 change to different states 110, thereby changing the sensor module's initial character or characters 80 to a different character or different characters 120. Consequently, the machine-readable sensor-embedded dynamic barcode 10 now conveys a second code 130. If the indicia 90 are irreversible, the machine-readable sensor-embedded dynamic barcode 10 will retain the second code 130. Alternatively, if the indicia 90 are reversible, and if the property or the level of the property of interest drops below the threshold of the sensor module 70, the machine-readable sensor-embedded dynamic barcode 10 will convey its first code 100, as illustrated in FIG. 1A.

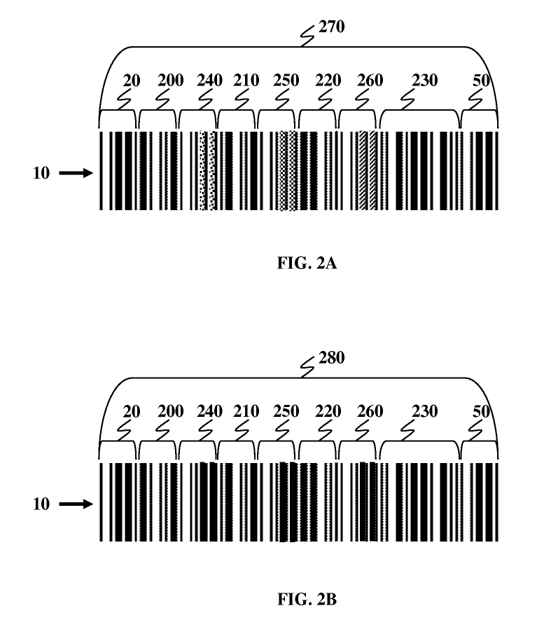

An alternate embodiment of the machine-readable sensor-embedded dynamic barcode of the embodiments herein is illustrated in FIGS. 2A and 2B. FIG. 2A is an illustrative example of the machine-readable sensor-embedded dynamic barcode 10 comprising a start character 20 followed by interspersed unchangeable regions 200, 210, 220, and 230 with changeable regions 240, 250, and 260, and ending in a termination character 50. The machine-readable sensor-embedded dynamic barcode displays an initial code 270 prior to exposure to a property or properties of interest or to a level of a property or level of properties of interest. FIG. 2B is an illustrative example of the machine-readable sensor-embedded dynamic barcode 10 of FIG. 2A during or after exposure to one or more properties of interest or to one or more levels of one or more properties of interest. During or after exposure, the machine-readable sensor-embedded dynamic barcode 10 displays a different code 280.

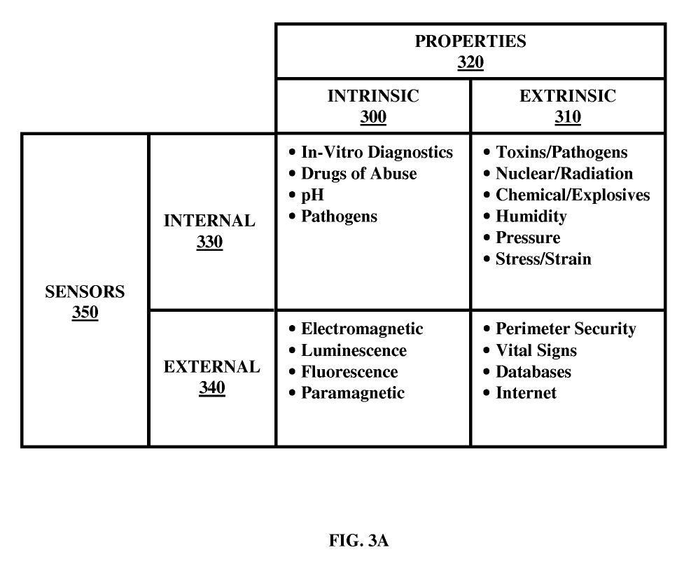

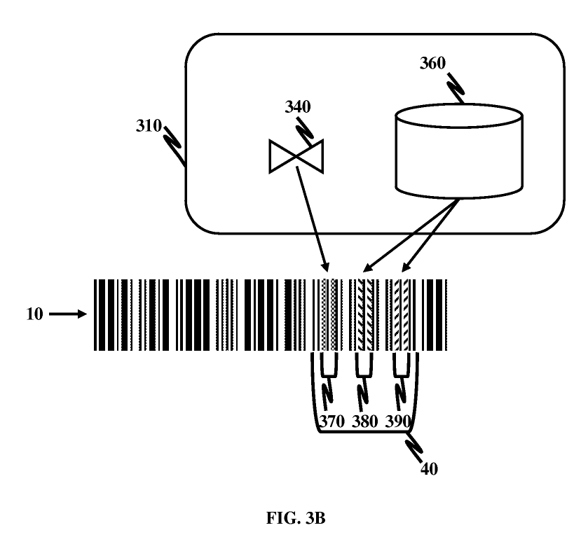

An additional embodiment of the machine-readable sensor-embedded dynamic barcode of the embodiments herein is adapted so that one or more properties of interest, or one or more levels of one or more properties of interest, can be intrinsic or extrinsic to the sensor-embedded barcode, and one or more sensors can be internal or external to the sensor-embedded barcode. FIG. 3A illustrates some, but not all, of the possible combinations of one or more intrinsic 300 or extrinsic 310 properties of interest 320 with one or more internal 330 or external 340 sensors 350. FIG. 3B illustrates an example of one section of FIG. 3A in which at least one of the properties of interest are extrinsic 310 to, and at least one of the sensors are external 340 to the machine-readable sensor-embedded dynamic barcode 10. In this particular example, the changeable region 40 of the machine-readable sensor-embedded dynamic barcode 10 consists of three pairs of indicia 370, 380, and 390, which encode data from an external sensor 340 and from an external database 360.

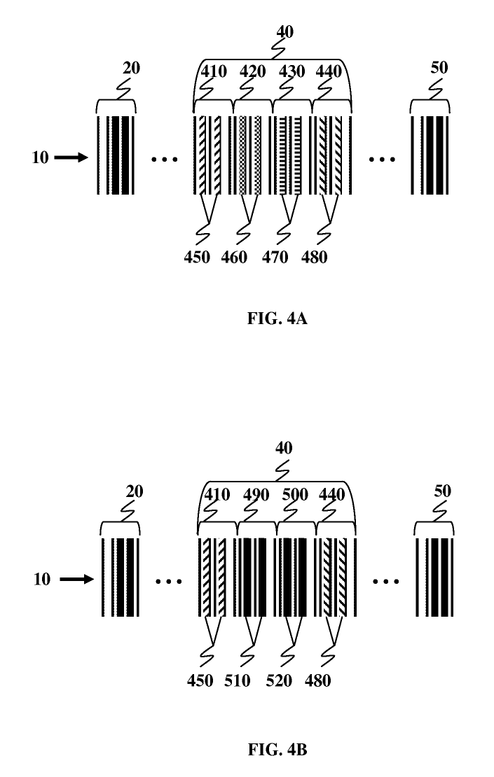

An alternate embodiment of the machine-readable sensor-embedded dynamic barcode of the embodiments herein is illustrated in FIGS. 4A and 4B whereby each sensor module is coded to portray qualitative or binary exposure to one or more properties of interest. The unchangeable regions of the barcode have been omitted for clarity. FIG. 4A illustrates an example of the machine-readable sensor-embedded dynamic barcode 10 comprising a start module 20, a changeable region 40 containing four different sensor modules 410, 420, 430, and 440, and a termination module 50 prior to exposure to any of the four chosen properties of interest. Each sensor module contains a pair of changeable indicia 450, 460, 470, and 480 that are configured to code for qualitative (binary) changes in the four chosen properties of interest. FIG. 4B illustrates that after sufficient exposure to two of the four properties of interest, indicia 510 and 520 have changed states resulting in a change in the codes of sensor modules 490 and 500, respectively, and consequently a change in the overall code of the sensor-embedded barcode 10. Since the other two sensor modules 410 and 440 were not sufficiently exposed to their respective properties of interest, their indicia 450 and 480 remain unchanged.

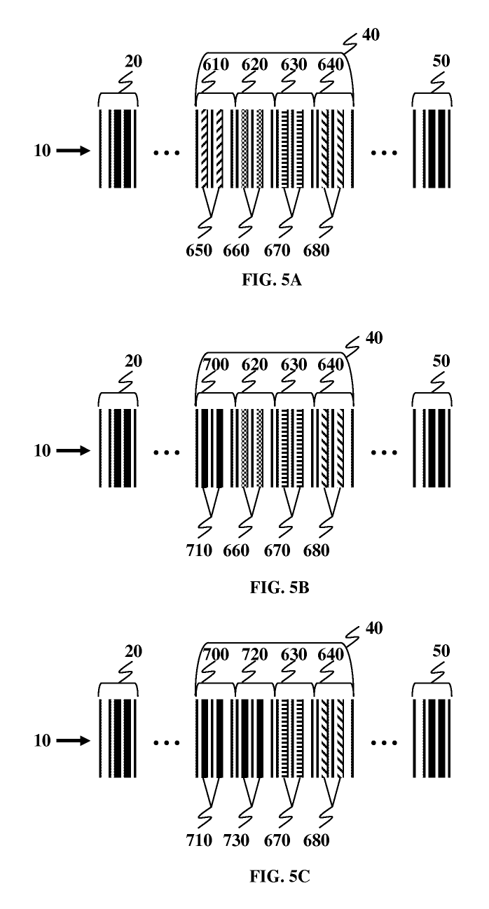

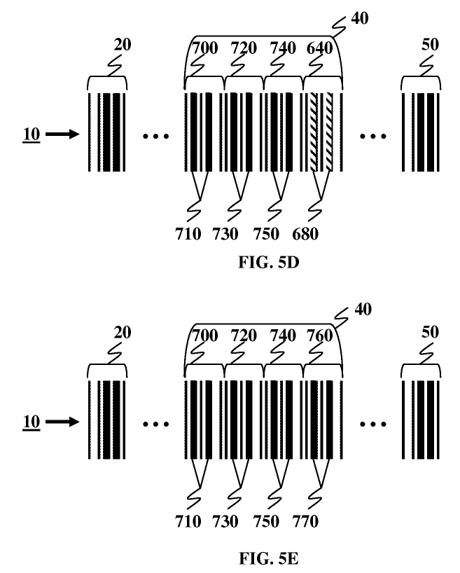

An alternate embodiment of the machine-readable sensor-embedded dynamic barcode of the embodiments herein is illustrated in FIGS. 5A through 5E, whereby sensor modules code for quantitative levels of exposure to one or more properties of interest. In this particular alternate embodiment, the quantitative levels of exposure to one or more properties of interest are coded using a thermometer code, though other coding schemes are also implementable. Again, the unchangeable regions of the barcode have been omitted for clarity. FIG. 5A illustrates the machine-readable sensor-embedded dynamic barcode 10, start symbol 20, changeable region 40 comprising sensor modules 610, 620, 630, and 640 further comprising sensor indicia 650, 660, 670, and 680 respectively, and a termination module 50. Prior to exposure to one or more levels of the one or more chosen properties of interest, the machine-readable sensor-embedded dynamic barcode 10 codes a first code. FIG. 5B illustrates that when a first level of one or more chosen properties of interest has been exceeded, sensor indicia 710 change state and sensor module 700 codes this change in state. Consequently, the machine-readable sensor-embedded dynamic barcode 10 codes a second state. FIG. 5C illustrates that when a second level of one or more chosen properties of interest has been exceeded, the second sensor indicia 730 change state and sensor module 720 codes this change in state. Consequently, the machine-readable sensor-embedded dynamic barcode 10 codes a third state. FIG. 5D illustrates that when a third level of one or more chosen properties of interest has been exceeded, the third sensor indicia 750 change state and sensor module 740 codes this change in state. Consequently, the machine-readable sensor-embedded dynamic barcode 10 codes a fourth state. FIG. 5E illustrates that when the fourth and final level of one or more chosen properties of interest has been exceeded, the fourth sensor indicia 770 change state and sensor module 760 codes this change in state. Consequently, the machine-readable sensor-embedded dynamic barcode 10 codes a fifth state.

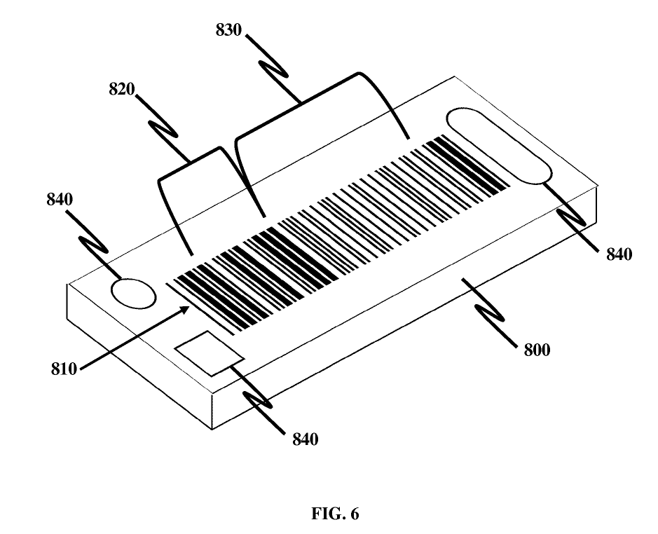

A preferred embodiment of the standalone machine-readable sensor-embedded barcode device of the embodiments herein is illustrated in FIG. 6. A substrate 800 contains the sensor-embedded dynamic barcode device 810 comprising unchangeable regions 820 and changeable regions 830. The substrate 800 supplies structural support using materials including, but not limited to, semiconductor, electronic, metallic, ceramic, polymeric, paper, wood, or composites thereof. Furthermore, the substrate 800 provides operational support using active display technologies or actuators including, but not limited to, liquid crystal displays (LCD), light emitting diodes (LED), organic light emitting diodes (OLED), laser diodes (LD), micro-electromechanical (MEMS) devices, or plasma displays, or passive display technologies including, but not limited to, retroreflective materials, thermochromic materials, wavelength specific materials or polarized materials. In addition, the substrate 800 may contain one or more devices 840 that can be integrated within or on the substrate 800 including, but not limited to, power supplies, energy harvesting devices, transceivers, timers, clocks, shutters, diaphragms, irises or beacons.

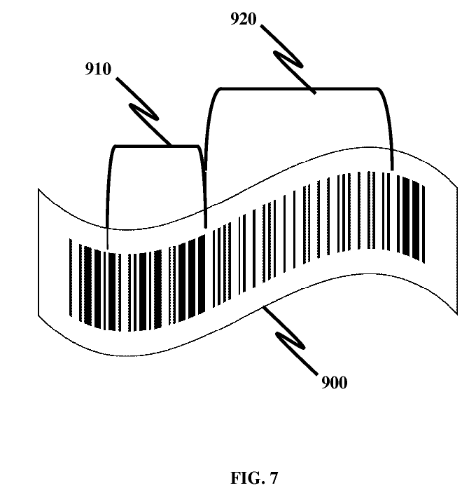

A preferred embodiment of the machine-readable sensor-embedded dynamic barcode label of the embodiments herein is illustrated in FIG. 7. The sensor-embedded barcode label 900 comprises unchangeable regions 910 and changeable regions 920. When affixed to an object, the sensor-embedded barcode label 900 allows for coding of a chosen property or chosen properties of interest that are of significance to the object. For example, the sensor-embedded barcode label 900 can be affixed to a tomato to sense the presence of salmonella and, if present, code for the salmonella qualitatively or quantitatively.

Standard barcode scanning technologies including, but not limited to, laser scanners, one- and two-dimensional CCD imagers, cell phone cameras, digital cameras and/or webcams as well as specialized 3D laser and imaging technologies can be used to read the machine readable sensor-embedded dynamic barcode, barcode device or barcode label of the embodiments herein.

Autonomous reading of the sensor-embedded dynamic barcode, barcode device or barcode label can be performed close to the barcode or at a substantial distance from the barcode using advanced laser designator techniques, remote imaging or optical techniques.

When the barcode scanning device has computational or communications capabilities, the sensor-embedded barcode's code can be either locally interpreted and reported or communicated to a remote location where the code can be interpreted, and the result communicated back to the barcode scanning device.

A database at the local or remote locations can be used to interpret the sensor-embedded barcode's present or previous code. Scanned codes can be added to the database to facilitate further analysis and prognostics.

Equipment for the creation of sensor-embedded barcodes can use standard barcode printing methods including, but not limited to, embossing techniques, ink-jet printers or specialized printing, embossing, holographic, nano-fabrication and MEMS fabrication technologies.

The embodiments herein further the current state of the art by introducing sensor-embedded barcodes that enhance static barcodes through the addition of sensors or actuators to become dynamic barcodes, barcode labels or barcode devices. The code displayed by a sensor-embedded barcode can change from an initial code to one of many different codes depending on the level of exposure to one or more sensed properties, a range in one or more sensed properties or a combination of one or more sensed properties.

One or more sensing modules are embedded into the dynamic barcode, barcode device or barcode label of the embodiments herein, and comprise one or more characters of one-, two- or three-dimensional barcode symbol sets. A symbol can be realized with a code that renders its particular characters using sensing indicia. The sensor-embedded dynamic barcode, barcode device, or barcode label of the embodiments herein also comprises one or more unchangeable product-level or item-level identification codes as in conventional barcodes.

Data coded by the dynamic barcode, barcode device or barcode label of the embodiments herein can be machine-readable or visible to the naked eye, and can be autonomously scanned and added to a database for further analysis or to facilitate prognostics.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A barcode comprising:
at least one unchangeable region comprising pre-determined fixed data of said barcode; and
at least one changeable region comprising at least one internal or external sensor for sensing or measuring a property of interest and rendering said property of interest within said barcode.

2. The barcode of claim 1, wherein said at least one unchangeable region and said at least one changeable region are disposed in any of contiguous modules, separated modules, and concatenated modules, and wherein all of the modules comport with a chosen barcode symbol set.

3. The barcode of claim 2, wherein said chosen barcode symbol set is disposed in any of one dimension, two dimensions, and three dimensions.

4. The barcode of claim 1, wherein said at least one property of interest comprises any of:
physical and environmental factors including pressure, temperature, humidity, vibration, shock, stress, strain, and pH;
chemical factors including acidic and basic concentrations, toxicity, solubility, wetability, corrosion, and absorbability;
biological factors including a presence or concentrations of antibodies, antigens, analytes, enzymes, toxins, food agents, bacteria, pathogens, or drugs of abuse;
nuclear factors including a presence or flux of natural or man made nuclear particles or radiation;
medical factors including patients' blood pressure, blood sugar, temperature, heart rate, cardiac condition, and constituents of vital body fluids; and
pharmaceutical factors including a presence or concentrations of prescription drugs, over-the-counter drugs, nutraceuticals, food supplements, food additives, tobacco, and alcohol.

5. The barcode of claim 1, wherein said at least one internal or external sensor conveys qualitative sensed and measured properties comprising on-or -off states triggered at predetermined thresholds of the at least one property of interest.

6. The barcode of claim 1, wherein said at least one internal or external sensor conveys quantitative sensed or measured properties comprising a multiplicity of states of said property of interest.

7. The barcode of claim 6, wherein each quantitatively sensed or measured properties are conveyed by said changeable region and are disposed in any of a single module and multiple modules.

8. The barcode of claim 1, wherein said at least one unchangeable region and said at least one changeable region is fabricated on a substrate comprising any of electronic, metallic, ceramic, polymeric, paper, wood, and composites thereof.

9. The barcode of claim 1, wherein said at least one unchangeable region and said at least one changeable region are interpreted by any of visual inspection; a barcode reading device; an imaging device; a machine reading device; a magnetic field detecting device; an electric field detecting device; an electro-optical device; a conductivity detecting device; a luminescence detecting device; a fluorescence detecting device; a photoluminescence detecting device; and a chemiluminescence detecting device.

10. The barcode of claim 1, wherein said property of interest is rendered any of qualitatively and quantitatively within said barcode.

11. The barcode of claim 10, wherein said property of interest comprises qualitative information conveyed from at least one internal sensor.

12. The barcode of claim 10, wherein said property of interest comprises quantitative information conveyed from at least one internal sensor.

13. The barcode of claim 10, wherein said property of interest comprises information conveyed from at least one external sensor.

14. The barcode of claim 1, wherein said at least one unchangeable region comprises computer-readable codes that represent a sensor or a test type in a database.

15. The barcode of claim 1, wherein said at least one unchangeable region is disposed in any of pre-specified contiguous modules of said barcode, and pre-specified separated modules of said barcode.

16. A barcode device comprising:
at least one unchangeable region comprising pre-determined fixed data of said barcode; and
at least one changeable region comprising at least one internal or external sensor for collecting and rendering data within said barcode from a device external to, and in communication with, said barcode device.

17. The barcode device of claim 16, wherein said data comprise any of chemical, physical, biological, nuclear, radiological, medical, pharmaceutical, and pharmacological data.

18. A barcode label comprising:
an unchangeable region comprising pre-determined fixed data of said barcode; and
a changeable region comprising a sensor for determining a property of interest and rendering said property of interest within said barcode.

19. The barcode label of claim 18, wherein said sensor is internal to said changeable region.

20. The barcode label of claim 18, wherein said sensor is external to said changeable region.
